(19) United States
(12) Patent Application Publication
(10) Pub. No.: US 2011/0008757 A1
(43) Pub. Date: Jan. 13, 2011

(54) STRESS RELIEVER AND METHOD OF USING SAME

(76) Inventors: Holly Jo Lindroth, Los Alamitos, CA (US); Cinnamon Johnston, Los Alamitos, CA (US)

Correspondence Address: DUCKOR SPRADLING METZGER & WYNNE;A LAW CORPORATION, 3043 4th Ave., SAN DIEGO, CA, 92103, US

(21) Appl. No.: 12/831,571

(22) Filed: Jul. 7, 2010

Related U.S. Application Data
(60) Provisional application No. 61/223,668, filed on Jul. 7, 2009.

(51) Int. Cl. G09B 19/10

(52) U.S. Cl. 434/82

(57) ABSTRACT

A stress reliever and method of using it according to certain embodiments of the invention may include a box, a mat, modeling clay, clay modeling tools, and modeling inspiration cards.

### RELATED APPLICATION

The application claims priority to U.S. provisional patent application No. 61/223,668, entitled STRESS RELIEVER AND METHOD OF USING SAME, filed Jul. 16, 2009, which is incorporated herein by reference.

### FIELD OF THE INVENTION

The present invention relates in general to a stress reliever and method of using it. It more particularly relates to a box, a mat, modeling clay, clay modeling tools, and modeling inspiration cards, and a method of using the same to relieve stress.

### BACKGROUND ART

This section describes the background of the disclosed embodiment of the present invention. There is no intention, either express or implied, that the background art discussed in this section legally constitutes prior art.

According to the Jun. 6, 1983 cover story of TIME magazine, entitled STRESS! Seeking Cures for Modern Anxieties, “In the past 30 years, doctors and health officials have come to realize how heavy a toll stress is taking on the nation's well being. According to the American Academy of Family Physicians, two-thirds of office visits to family doctors are prompted by stress-related symptoms. At the same time, leaders of industry have become alarmed by the huge cost of such symptoms in absenteeism, company medical expenses and lost productivity. Based on national samples, these costs have been estimated at $50 billion to $75 billion a year, more than $750 for every U.S. worker. Stress is now known to be a major contributor, either directly or indirectly, to coronary heart disease, cancer, lung ailments, accidental injuries, cirrhosis of the liver and suicide—six of the leading causes of death in the U.S.”

The American Institute of Stress (AIS) website, at www.stress.org, states that “occupational pressures and fears are far and away the leading source of stress for American adults and . . . these have steadily increased over the past few decades.” The AIS website refers to a National Institute for Occupational Safety and Health (NIOSH) survey from the 1990's, where “40% of workers reported their job was very or extremely stressful and 25% of workers view their jobs as the number one stressor in their lives”. The AIS website also refers to “a 1999 government report that found that the number of hours worked increased 8% in one generation to an average 47 hrs/week with 20% working 49 hrs/week”.

A significant source of workplace stress is job insecurity. With the widespread job loss due to the current state of our economy, workplace stress due to job insecurity will only increase. Treating this stress can be very costly. The AIS website reports that “in California, the number of Workers' compensation claims for mental stress increased by almost 700 percent over eight years and ninety percent were successful with an average award of $15,000 compared to a national average of $3,420” and “in 1987, California shelled out almost $1,000,000,000 for medical and legal fees alone, which is more than most states spend on actual awards.”

According to the AIS website “It is not the job but the person-environment fit that matters. Some individuals thrive in the time urgent pressure cooker of life in the fast lane, having to perform several duties at the same time and a list of things to do that would overwhelm most of us—provided they perceive that they are in control. . . . Stress is a highly personalized phenomenon and can vary widely even in identical situations for different reasons. . . . The severity of job stress depends on the magnitude of the demands that are being made and the individual's sense of control or decision-making latitude he or she has in dealing with them. Scientific studies based on this model confirm that workers who perceive they are subjected to high demands but have little control are at increased risk for cardiovascular disease.”

There are various desktop toys commercially available that serve to temporarily divert a worker's attention away from workplace stress, such as the swinging pendulum device known as Newton's cradle, pin art, perpetual motion toys, liquid motion toys, and hand manipulable devices, such as the device described in U.S. Pat. No. 6,250,988, foam stress balls, and the puzzle device described in U.S. Pat. No. 5,988,639. However, these toys have little therapeutic value in helping workers deal with the negative emotions that are caused by workplace stress.

The negative emotions caused by workplace stress are more effectively treated by managing workplace stress and releasing the negative emotions caused by it by consulting with a professional therapist, participating in athletic activities, and/or engaging in artistic pursuits. However, it is often impractical for many workers to find time to escape their demanding work environment to engage in these therapeutic activities.

Artistic pursuits have been found to be especially therapeutic. According to the American Art Therapy Association, at www.arttherapy.org, “Art therapy is a mental health profession that uses the creative process of art making to improve and enhance the physical, mental and emotional well-being of individuals of all ages. It is based on the belief that the creative process involved in artistic self-expression helps people to resolve conflicts and problems, develop interpersonal skills, manage behavior, reduce stress, increase self-esteem and self-awareness, and achieve insight.”

Although art therapy can be rather effective in treating stress, the use and storage of art supplies, such as an art easel, paint, or a pottery wheel in a worker's work space would be perceived as unprofessional or even comical in many work environments, and would be frowned upon by most employers. Furthermore, meeting with an art therapist or taking an art class is an expensive and time consuming luxury that is unattainable for many workers who are trying desperately to juggle the demands of a hectic work schedule, household bills, and family responsibilities. Thus, there is a need for an economical, yet professional, way to incorporate art therapy into a worker's daily routine to help alleviate the negative emotions caused by workplace stress.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a stress reliever, with a front plan view of the box in an open position so that the stress relieving contents may be viewed.

FIG. 2 is a pictorial view of various clay modeling tools, with an entire clay modeling tool (decorative handle and tool head) depicted in FIG. 2A, and additional clay modeling tool heads depicted in FIG. 2B through FIG. 2N.

FIG. 2A is a pictorial view of a cone shaped die clay modeling tool head.

FIG. 2B is a pictorial view of an oval shaped spatula clay modeling tool head.

FIG. 2C is a pictorial view of a cylindrical shaped die clay modeling tool head.

FIG. 2D is a pictorial view of a wire loop scraper clay modeling tool head.

FIG. 2E is a pictorial view of a rhombus shaped spatula clay modeling tool head.

FIG. 2F is a pictorial view of a three tiered graduated sphere (snowman) shaped die clay modeling tool head.

FIG. 2G is a pictorial view of a prolate spheroid (football) shaped die clay modeling tool head with a tapered end.

FIG. 2H is a pictorial view of an octagram (8 pointed star) shaped die clay modeling tool head.

FIG. 2I is a pictorial view of a beaded rotatable drum die clay modeling tool head.

FIG. 2J is a pictorial view of a heart shaped die clay modeling tool head.

FIG. 2K is a pictorial view of a spiral shaped die clay modeling tool head.

FIG. 2L is a pictorial view of a die clay modeling tool head resembling the Sanskrit symbol for the mantra “vam”.

FIG. 2M is a pictorial view of a die clay modeling tool head resembling the Sanskrit symbol for the mantra “om”,

FIG. 2N is a pictorial view of a snake shaped die clay modeling tool head.

FIG. 3 is a pictorial view of a rolling pin clay modeling tool.

FIG. 4 is a pictorial view of a tool pouch holding various clay modeling tools.

FIG. 5 is a pictorial view of the method of relieving stress using the stress reliever depicted in FIG. 1.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A stress reliever and a method of using it according to certain embodiments of the invention may include modeling clay, a container for containing the modeling clay, a mat, at least one modeling inspiration card, at least one clay modeling tool, a pouch for holding the clay modeling tools, and a decorative wooden box for containing the modeling clay, the container, the mat, the modeling inspiration cards, the clay modeling tools, and the pouch.

According to certain embodiments of the invention the at least one clay modeling tool may be comprised of a decorative tool handle and a clay modeling tool head.

The clay modeling tool head may be used for modeling and sculpting the clay and for adding decorative detail to the modeled clay.

The clay modeling tool head may be securely or removably fastened to the decorative tool handle, and may be positioned in line with the decorative handle, perpendicular to the decorative handle, or less than 90 degrees out of line with the decorative handle.

According to some embodiments of the invention, the clay modeling tool head may be shaped for functionality for sculpting and modeling. The clay modeling tool head may be a cone shaped die. The clay modeling tool head may be prolate spheroid (football) shaped die with a tapered end. The clay modeling tool head may be a flat spatula die, which may have an oval shape or a rhombus shape. The clay modeling tool head may be a cylindrical shaped die. The clay modeling tool head may be a wire loop scraper.

According to other embodiments of the invention, the clay modeling tool head may be shaped for adding decorative detail to the modeled clay. The clay modeling tool head may be a beaded rotatable drum die. The clay modeling tool head may be a three tiered graduated sphere (snowman) shaped die. The clay modeling tool head may be a heart shaped die.

The clay modeling tool head may be a die which resembles a Gnostic symbol, which may be an octagram (eight pointed star). The Gnostic octagram symbol is often referred to as the Octagram of Creation, is thought to be related to Venus, and in Nordic traditions is used in Wicca to invoke magick and as a protecting ideogram.

The clay modeling tool head may be a die which resembles a pattern or thing found in nature, which may be a spiral or may be a snake shaped die. A spiral is a pattern found in nature, that has been used by different cultures to represent birth, death, and rebirth. A snake symbol is used in some cultures to represent the cyclic processes of nature and time.

The clay modeling tool head may be a die resembling a symbol derived from Eastern culture, which may be the Sanskrit symbol for the mantra “yam” or the Sanskrit symbol for the mantra “om”. The “vain” mantra is the Sanskrit symbol for desire, and it is often used within the sacral chakra symbol in ayurvedic medicine. The “om” mantra is a sacred exclamation that is uttered at the beginning or end of a prayer in Hindu, Jain, and Buddhist religions.

The tool heads bearing the symbols described above that are associated with Gnosticism, nature, and Eastern culture may further aid the user in relieving stress when the user associates the symbol with spirituality, peace, and meditation. Other tool heads, not described herein, bearing symbols associated with nature, religion, spirituality, meditation, alternative medicine, Eastern culture, and Ayurvedic medicine may also be used.

In further embodiments, the decorative tool handle may be adorned with a decorative stone. The decorative stone may be a gemstone. The decorative stone may be a stone of the type used by alternative medicine practitioners for crystal healing. Stones have been used in various cultures for healing or protection throughout the ages. Crystals are sometimes used in Ayurvedic medicine in connection with healing and balancing the various chakra points (energy points) of the body.

In other embodiments, the decorative tool handle may be adorned with a magnet of the type used for magnet therapy.

According to another embodiment of the invention, the decorative tool handle may be comprised of a precious metal and/or a base metal.

According to yet another embodiment of the invention, the at least one clay modeling tool may be comprised of a rolling pin clay modeling tool. The rolling pin may be adorned with a decorative stone. The decorative stone may be a gemstone. The decorative stone may be a stone of the type used by alternative medicine practitioners for crystal healing. The rolling pin may be adorned with a magnet of the type used for magnet therapy. The rolling pin may be comprised of a precious metal and/or a base metal.

In other embodiments of the invention, the mat may be comprised of a pliable material that allows for easy folding and unfolding of the mat so that it may provide an adequately sized work surface and yet still be easily stored within the decorative wooden box. According to another embodiment of the invention, the mat is comprised of a wipeable material to allow for easy clean up.

According to yet another embodiment of the invention, the modeling clay may be infused with an essential oil of the type used for aromatherapy. Aromatherapy is a form of alternative medicine that uses volatile liquid plant materials, known as essential oils and other aromatic compounds from plants for the purpose of affecting a person's mood or health.

In another embodiment of the invention the container for holding the modeling clay is an airtight container. The container may be made of tine or pewter.

In further embodiments, the decorative wooden box may be a decorative object suitable for display in a professional environment. The decorative wooden box may be a subtle, sophisticated, and/or elegant accessory for an office or desk top. The decorative wooden box may have dividers inside to create discrete compartments to contain the modeling clay container, modeling inspiration cards, mat, and clay modeling tool pouch.

According to another embodiment of the invention, the stress reliever described above may be used as a form of art therapy to relieve stress. The method by which this would occur may include the following steps, in no particular order:

opening the decorative wooden box;

retrieving the mat from said decorative wooden box;

laying the mat out on a flat surface;

selecting one of the at least one modeling inspiration card;

opening the container and removing said modeling clay;

modeling the modeling clay to form a clay object that resemble the object described on the modeling inspiration card;

using the clay modeling tools to add detail to the clay object; and

repeating the steps outlined above until the negative emotions due to stress are relieved.

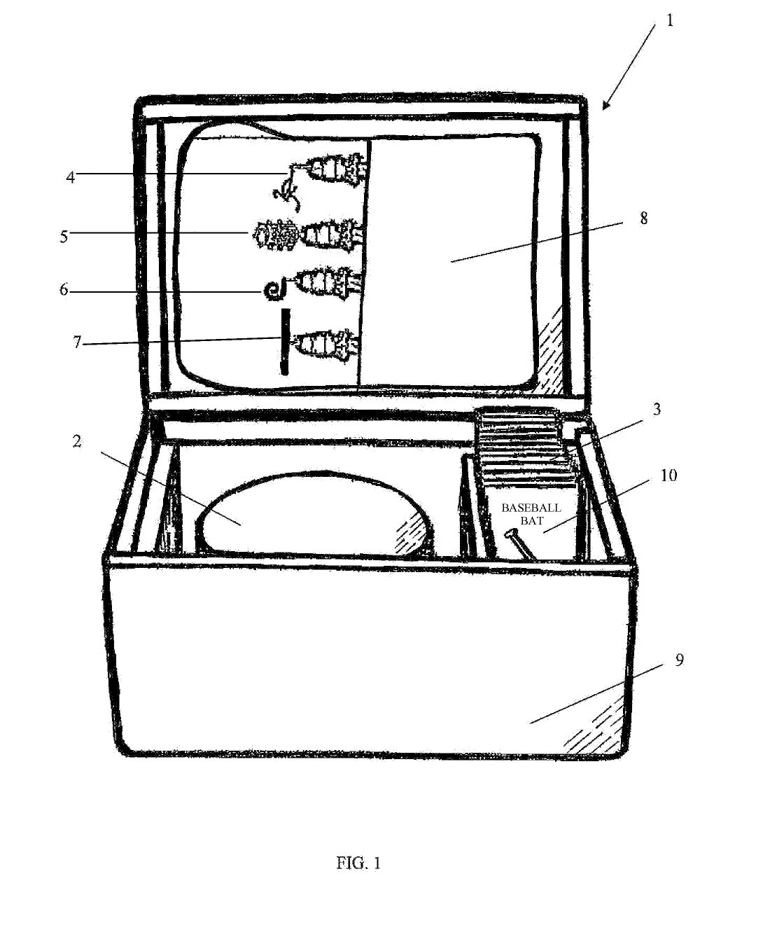

Referring now to the figures, FIG. 1 shows an embodiment of the stress reliever 1 of the invention. This stress reliever includes modeling clay (not shown in FIG. 1), a container 2 for containing the modeling clay, a mat (not shown in FIG. 1), modeling inspiration cards 3, clay modeling tools 4-7, a pouch for holding the clay modeling tools 8, and a decorative wooden box 9 for containing the modeling clay, the container, the mat; the modeling inspiration cards, the clay modeling tools, and the pouch. The first shown card 10 of the modeling inspiration cards 3 contains the wording “baseball bat” along with a drawing of a baseball bat. Clay modeling tool 4 has a clay modeling tool head resembling the Sanskrit symbol for “om”. Clay modeling tool 5 has a beaded rotatable drum die for the clay modeling tool head. Clay modeling tool 6 has spiral for the clay modeling tool head. Clay modeling tool 7 has a clay modeling tool head in the form of a cylindrical shaped die.

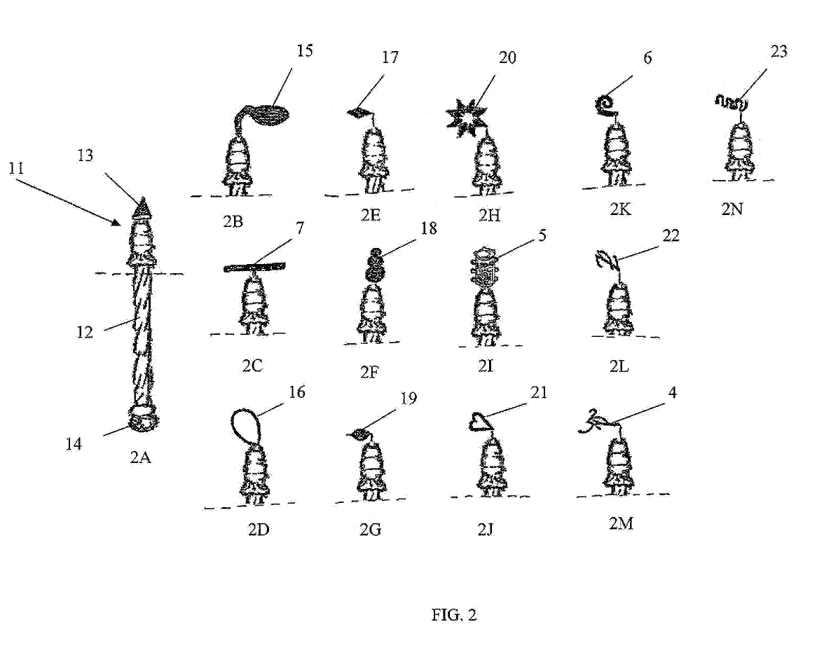

FIG. 2 depicts various clay modeling tools that may be included with the stress reliever. FIG. 2A shows an entire clay modeling tool 11, which is comprised of a decorative tool handle 12 and a clay modeling tool head 13. The clay modeling tool head may be securely or removably fastened to the decorative tool handle, and may be positioned in line with the decorative handle, perpendicular to the decorative handle, or less than 90 degrees out of line with the decorative handle. The decorative handle 12 of the clay modeling tool 11 is adorned with a decorative stone 14. The decorative stone may be a gemstone or a stone of the type used in crystal healing. Alternatively, the decorative handle may be adorned with a magnet of the type used in magnet therapy. The decorative handle may be comprised of a base metal or a precious metal.

The clay modeling tool head 13, shown in FIG. 2A, is a cone shaped die.

FIG. 2B shows a break away view of a clay modeling tool with a clay modeling tool head in the form of a flat oval shaped spatula 15.

FIG. 2C shows a break away view of a clay modeling tool with a clay modeling tool head in the form of a cylindrical shaped die 7.

FIG. 2D shows a break away view of a clay modeling tool with a clay modeling tool head in the form of a wire loop scraper 16.

FIG. 2E shows a break away view of a clay modeling tool with a clay modeling tool head in the form of a flat rhombus shaped spatula 17.

FIG. 2F shows a break away view of a clay modeling tool with a clay modeling tool head in the form of a three tiered graduated sphere shaped die 18.

FIG. 2G shows a break away view of a clay modeling tool with a clay modeling tool head in the form of a prolate spheroid (football) shaped die 19 with a tapered end.

FIG. 2H shows a break away view of a clay modeling tool with a clay modeling tool head in the form of an octagram 20.

FIG. 2I shows a break away view of a clay modeling tool with a clay modeling tool head in the form of a beaded rotatable drum die 5.

FIG. 2J shows a break away view of a clay modeling tool with a clay modeling tool head in the form of a heart shaped die 21.

FIG. 2K shows a break away view of a clay modeling tool with a clay modeling tool head in the form of a spiral shaped die 6.

FIG. 2L shows a break away view of a clay modeling tool with a clay modeling tool head in the form of a die resembling the Sanskrit symbol for “yam” 22.

FIG. 2M shows a break away view of a clay modeling tool with a clay modeling tool head in the form of a die resembling the Sanskrit symbol for “om” 4,

FIG. 2N shows a break away view of a clay modeling tool with a clay modeling tool head in the form of a snake shaped die 23.

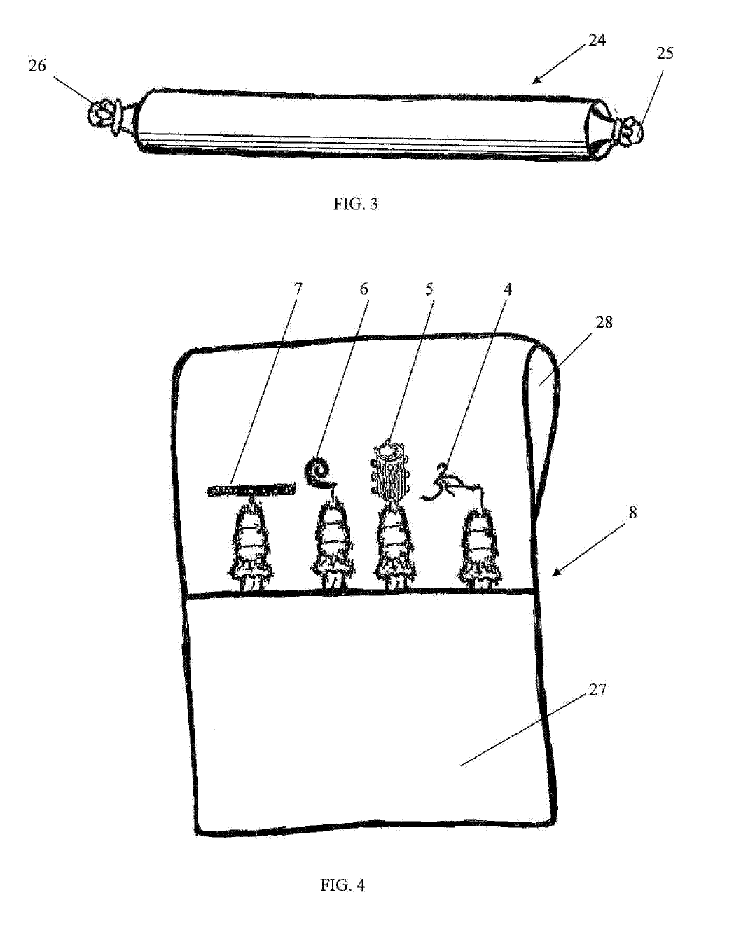

FIG. 3 shows a rolling pin clay modeling tool 24. The rolling pin is adorned with decorative stones 25-26 at each end. The decorative stones may be gemstones or may be stones of the type used by alternative medicine practitioners for crystal healing. Alternatively, the rolling pin may be adorned with magnets of the type used for magnet therapy. The rolling pin may be comprised of a precious metal and/or a base metal.

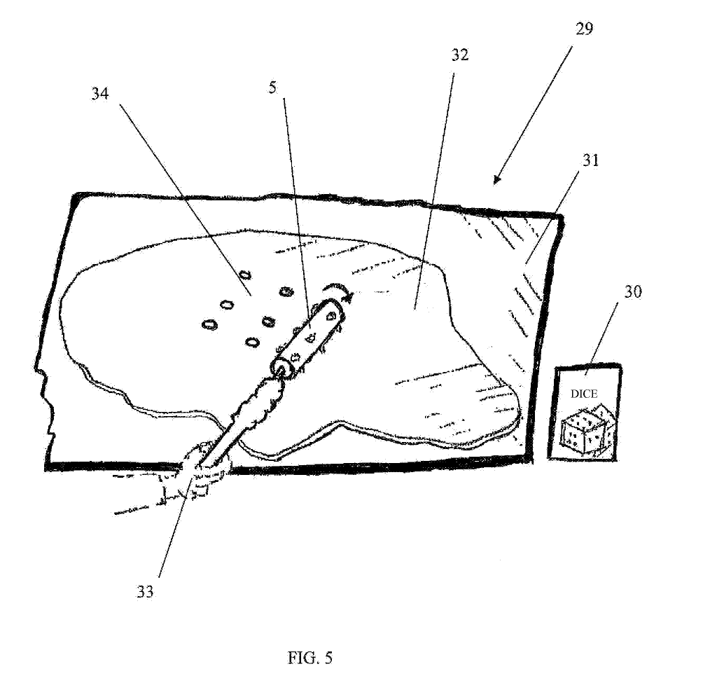

FIG. 4 shows a pouch for holding the clay modeling tools 8. The bottom portion of the pouch 27 forms a pocket to contain clay modeling tools. The top of portion of the pouch 28 has a flap that can be used to cover the clay modeling tools when the flap is closed and which can be opened to reveal the clay modeling tools. The pouch is shown with the flap open in FIG. 4 with clay modeling tools 4-7 shown.

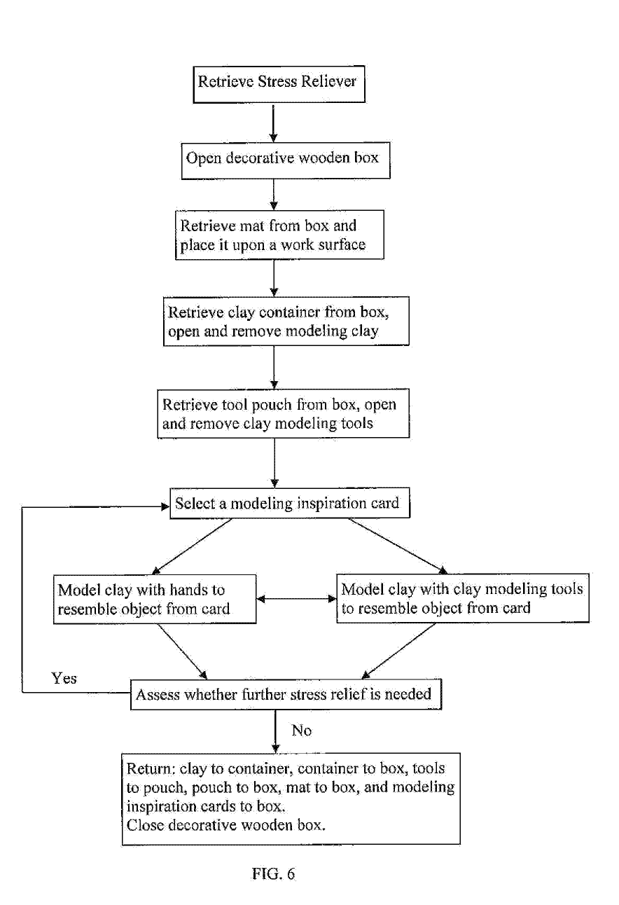

FIG. 5 demonstrates the method 29 of using the stress relieving kit 1 of FIG. 1. Modeling inspiration card 30 containing the wording “dice” along with a drawing of a pair of dice. A mat 31 has been laid out upon a flat surface. Modeling clay 32 has been rolled out flat upon the mat 31, by use of the rolling pin 24 (not shown in FIG. 5) on the clay 32. The user 33 of the stress relieving kit 1 is shown to be modeling the dice from the modeling inspiration card 30 by applying a dotted pattern 34 to the clay by rolling the beaded rotatable drum die 5 across the surface of the modeling clay 32.

FIG. 6 is a flowchart diagramming an embodiment of the method of using the stress relieving apparatus. This method includes the following steps: (1) retrieve stress reliever; (2) open decorative wooden box; (3) retrieve mat from box and place it upon a work surface; (4) retrieve clay container from box, open container and remove modeling clay; (5) retrieve tool pouch from box, open tool pouch and remove clay modeling tools; (6) select a modeling inspiration card; (7) model clay with hands and/or clay modeling tools to make the clay resemble the object from the card; (8) assess whether further stress relief is needed; (9) if further stress relief is needed repeat steps (6) and (7), if no further stress relief is needed then return the clay to the container, the container to the box, the clay modeling tools to the tool pouch, the tool pouch to the box, the mat to the box, and the modeling inspiration cards to the box and close the decorative wooden box.

While particular embodiments of the present invention have been disclosed, it is to be understood that various different embodiments are possible and are contemplated within the true spirit and scope of the appended claims. There is no intention, therefore, of limitations to the exact abstract or disclosure herein presented.

What is claimed is:

1. A stress reliever, said stress reliever comprising modeling clay;
a container for containing said modeling clay;
a mat;
at least one modeling inspiration card;
at least one clay modeling tool;
a pouch for holding said at least one clay modeling tools; and
a decorative wooden box for containing the modeling clay, the container, the mat;
the at least one modeling inspiration card, the at least one clay modeling tool, and the pouch.

2. The stress reliever of claim 1, wherein said at least one clay modeling tool is comprised of a decorative tool handle and a clay modeling tool head.

3. The stress reliever of claim 2, wherein said clay modeling tool head is selected from the group consisting of:
a clay modeling tool head that is permanently attached to said decorative tool handle;
a cone shaped die, wherein said cone shaped die is in line with said decorative handle;
an oval shaped spatula die, wherein said oval shaped spatula die is perpendicular to said decorative handle;
a cylindrical shaped die, wherein said cylindrical shaped die is perpendicular to said decorative handle;
a wire loop scraper, wherein said wire loop scraper less than 45 degrees out of line with said decorative handle;
a rhombus shaped spatula die, wherein said rhombus shaped spatula die is perpendicular to said decorative handle;
a three tiered graduated sphere shaped die, wherein said three tiered graduated sphere shaped die is in line with said decorative handle;
a tapered end prolate spheroid shaped die, wherein said tapered end prolate spheroid shaped die is in line with said decorative handle;
a die which resembles a Gnostic symbol, wherein said Gnostic symbol die is less than 90 degrees out of line with said decorative handle;
a beaded rotatable drum die, wherein said beaded rotatable drum die is in line with said decorative handle;
a heart shaped die, wherein said heart shaped die is less than 90 degrees out of line with said decorative handle;
a spiral shaped die, wherein said spiral shaped die is less than 90 degrees out of line with said decorative handle;
a die resembling a symbol derived from Eastern culture, wherein said die is about 90 degrees or less out of line with said decorative handle; and
a snake shaped die, wherein said snake shaped die is less than 90 degrees out of line with said decorative handle.

4. The stress reliever of claim 1, wherein said at least one clay modeling tool is comprised of a rolling pin clay modeling tool.

5. The stress reliever of claim 2, wherein said decorative tool handle is adorned with a decorative stone.

6. The stress reliever of claim 5, wherein said decorative stone is a gemstone.

7. The stress reliever of claim 5, wherein said decorative stone is a stone of the type used by alternative medicine practitioners for crystal healing.

8. The stress reliever of claim 2, wherein said decorative tool handle is adorned with a magnet of the type used for magnet therapy.

9. The stress reliever of claim 2, wherein said decorative tool handle is comprised of a base metal.

10. The stress reliever of claim 2, wherein said decorative tool handle is comprised of a precious metal.

11. The stress reliever of claim 1, wherein said mat is comprised of a pliable material.

12. The stress reliever of claim 1, wherein said mat is comprised of a wipeable material.

13. The stress reliever of claim 1, wherein said modeling clay is infused with an essential oil of the type used for aromatherapy.

14. The stress reliever of claim 1, wherein said decorative wooden box is a decorative object suitable for display in a professional environment.

15. A method of using the stress reliever of claim 1, wherein said method comprises opening the decorative wooden box;
retrieving the mat from said decorative wooden box;
laying the mat out on a flat surface;
selecting one of the at least one modeling inspiration card;
opening the container and removing said modeling clay;
modeling said modeling clay to form a clay object that resemble the object described on said modeling inspiration card; and
using said at least one clay modeling tools to add detail to said clay object.

16. The method of claim 15, wherein said at least one clay modeling tool is comprised of a decorative tool handle and a clay modeling tool head.

17. The method of claim 16, wherein said clay modeling tool head is a die that is comprised of a symbol that is associated with nature, religion, philosophy, or alternative medicine.

18. The method of claim 17, wherein said symbol comprises a Gnostic symbol, an octagram, a heart, a spiral, a Sanskrit symbol, the Sanskrit symbol for “yam”, the Sanskrit symbol for “om”, or a snake.

19. The method of claim 16, wherein said decorative tool handle is adorned with a decorative stone and wherein said decorative stone is a stone of the type used by alternative medicine practitioners for crystal healing.

20. The method of claim 15, wherein said decorative tool handle is adorned with a magnet of the type used for magnet therapy.
